(19) United States
(12) Patent Application Publication
(10) Pub. No.: US 2026/0329280 A1
(43) Pub. Date: Oct. 22, 2026

(54) AUTONOMOUS GROUND-MOVING ROBOT, METHOD FOR LOCALIZING A TARGET FOR AN AUTONOMOUS GROUND-MOVING ROBOT, AND METHOD FOR ADJUSTING ORIENTATION OF AN AUTONOMOUS GROUND-MOVING ROBOT

(71) Applicant: SOLOMON TECHNOLOGY CORPORATION, Taipei City (TW)

(72) Inventors: Cheng-Lung CHEN, Taipei City (TW); Xuan Loc NGUYEN, Taipei City (TW); Tsung-Cheng LAI, Taipei City (TW); Tafjira Nugraha BRILIAN, Taipei City (TW); Peng-Yan SIE, Taipei City (TW)

(21) Appl. No.: 19/569,514

(22) Filed: Mar. 17, 2026

Related U.S. Application Data
(63) Continuation-in-part of application No. 19/444,744, filed on Jan. 9, 2026.
Application No. 19/444,744 is a continuation-in-part of application No. 18/781,664, filed on Jul. 23, 2024, now Pat. No. 12,639,855.

(30) Foreign Application Priority Data
Apr. 3, 2024 (TW) 113112669
Jan. 9, 2026 (TW) 115100888

(51) Int. Cl. G05D 1/243; G06F 40/30; G06F 40/40; G06T 3/4007; G06T 3/60; G06T 7/50; G06T 7/70; G06V 10/25; G06V 10/26; G06V 20/58; H04N 23/67; H04N 23/69; H04N 23/695

(52) U.S. Cl. CPC G05D 1/2435; G06F 40/30; G06F 40/40; G06T 3/4007; G06T 3/60; G06T 7/50; G06T 7/70; G06V 10/25; G06V 10/26; G06V 20/58; H04N 23/671; H04N 23/69; H04N 23/695; G06T 2207/10024; G06T 2207/10028; G06T 2207/30261; G06V 2201/07

(57) ABSTRACT

A method for localizing a target for an autonomous ground-moving robot is implemented by a processing unit of the autonomous ground-moving robot and includes steps of: obtaining a surrounding image of the environment of the autonomous ground-moving robot; obtaining a point cloud related to the environment, and constructing a semantic three-dimensional (3D) map of the environment based on the point cloud; obtaining a target and an action command from a task; identifying a target object as the target in the surrounding image, and obtaining an image coordinate set of a position of the target object in the surrounding image; converting the image coordinate set to a 3D coordinate set relative to the range imaging module; determining a navigation path to the target object based on the semantic 3D map and the 3D coordinate set; and controlling the actuating module based on the action command.

### CROSS-REFERENCE TO RELATED APPLICATION

This is a continuation-in-part application of U.S. patent application Ser. No. 19/444744, filed on Jan. 9, 2026, which is a continuation-in-part application of U.S. patent application Ser. No. 18/781664, filed on Jul. 23, 2024, while U.S. patent application Ser. No. 18/781664 claims priority to Taiwanese Invention Patent Application No. 113112669, filed on Apr. 3, 2024. This application further claims priority to Taiwanese Invention Patent Application No. 115100888, filed on Jan. 9, 2026. The aforesaid applications are incorporated by reference herein in their entirety.

### FIELD

The disclosure relates to an autonomous ground-moving robot, a method for localizing a target for an autonomous ground-moving robot, and a method for adjusting orientation of an autonomous ground-moving robot.

### BACKGROUND

Autonomous ground-moving robots are increasingly used for inspection, monitoring, and inventory management in environments such as factories, warehouses, and other industrial facilities. Conventionally, many inspection tasks have relied on manual periodic inspections, which may be inefficient, labor-intensive, and may expose personnel to safety risks, particularly in hazardous or hard-to-reach environments. Although conventional autonomous ground-moving robots have been introduced to address these issues, these conventional autonomous ground-moving robots still suffer from several technical limitations.

Generally, a conventional autonomous ground-moving robot is equipped with a fixed-field-of-view camera or a single sensing device, which makes it difficult to observe relatively distant targets or relatively fine details. To compensate for such limitations, multiple fixed sensors are often deployed respectively at different targets that are difficult to be observed by the conventional autonomous ground-moving robot, which increases overall cost and complexity while blind spots may still be encountered. Therefore, the conventional autonomous ground-moving robot may not be reliable for detecting or localizing targets located at elevated positions or relatively long distances.

In addition, navigation and localization of the conventional autonomous ground-moving robot often rely on a pre-constructed map or path, such that the conventional autonomous ground-moving robot is not adaptable to dynamic or cluttered environments. Without the availability of global positioning system (GPS) signal in indoor environments, autonomous target searching and localization performance is limited and may be unreliable for the conventional autonomous ground-moving robot.

Some conventional systems used by the conventional autonomous ground-moving robots allow remote operators to manually adjust camera orientation based on map information or live images. However, such conventional systems remain operator-dependent and do not enable the conventional autonomous ground-moving robots to autonomously perform wide-area searching, zoomed inspection, three-dimensional (3D) target localization, or integration of target location information into a mapping framework for subsequent autonomous tasks.

These limitations are further exacerbated in a conventional autonomous ground-moving robot with a camera mounted on a relatively high position and unstable locomotion, such as humanoid or legged robots. Small pose estimation errors caused by gait instability, terrain irregularities, or sensor drift can be significantly magnified when the conventional autonomous ground-moving robot observe or interact with a target that is relatively distant, leading to significant errors in localization and orientation.

### SUMMARY

Therefore, an object of the disclosure is to provide an autonomous ground-moving robot, a method for localizing a target for an autonomous ground-moving robot and a method for adjusting orientation of an autonomous ground-moving robot that can alleviate at least one of the drawbacks of the prior art.

According to an aspect of the disclosure, the method for localizing a target for an autonomous ground-moving robot, where the autonomous ground-moving robot includes a camera module for capturing an image of an environment of the autonomous ground-moving robot, a range imaging module for obtaining depth data of the environment, an actuating module for moving the autonomous ground-moving robot, and a processing unit, is implemented by the processing unit. The method for localizing a target includes steps of: controlling the camera module to capture a surrounding image of the environment of the autonomous ground-moving robot, the surrounding image having multiple objects in the environment; controlling the range imaging module to obtain a point cloud related to the environment, and constructing a semantic three-dimensional (3D) map of the environment based on the point cloud; upon receiving a task that contains a target and an action command related to the target, processing the task to extract the target and the action command in the task; identifying a target object as the target from among the objects in the surrounding image, and obtaining an image coordinate set of a position of the target object in the surrounding image, the image coordinate set being defined by an image coordinate system related to the camera module; converting the image coordinate set to a 3D coordinate set defined by a sensor coordinate system fixed to the range imaging module; determining a navigation path to the target object in the environment based on the semantic 3D map and the 3D coordinate set; and controlling the actuating module to move the autonomous ground-MOVING robot based on the action command.

According to another aspect of the disclosure, the autonomous ground-moving robot includes an actuating module configured to move the autonomous ground-moving robot, a camera module configured to capture an image of an environment of the autonomous ground-moving robot, a range imaging module configured to obtain depth data of the environment, and a processing unit communicatively connected to the actuating module, the camera module and the range imaging module. The processing unit is configured to perform the method mentioned above for localizing a target.

According to yet another aspect of the disclosure, the method for adjusting orientation of an autonomous ground-moving robot, where the autonomous ground-moving robot includes a camera module for capturing an image of an environment of the autonomous ground-moving robot, a range imaging module for obtaining depth data of the environment, an actuating module for moving the autonomous ground-moving robot, and a processing unit. The method for adjusting orientation of the autonomous ground-moving robot includes steps of: controlling the camera module to capture a surrounding image of the environment of the autonomous ground-moving robot, the surrounding image having multiple objects in the environment; performing image segmentation on the surrounding image to obtain multiple initial image regions related respectively to the objects in the environment; controlling the range imaging module to obtain a point cloud related to the environment, and constructing a semantic 3D map of the environment based on the point cloud; upon receiving a task that contains a target and an action command related to the target, processing the task to extract the target and the action command in the task; identifying a target object as the target from among the objects in the surrounding image; obtaining a target position of the target object in the semantic 3D map, and determining a navigation path to the target object based on the semantic 3D map and the target position; and executing a movement procedure based on the action command. The movement procedure includes controlling the actuating module to move the autonomous ground-moving robot by a predetermined distance along the navigation path, the autonomous ground-moving robot being expected to be located at an expected position after accurately moving the predetermined distance along the navigation path; based on the predetermined distance, the semantic 3D map and the navigation path, deriving an expected image region from a reference image region that is one of the initial image regions related to the target object, the expected image region being an image region of an image captured by the camera module at the expected position; after controlling the actuating module to move the autonomous ground-moving robot, controlling the camera module to capture a current image of the environment of the autonomous ground-moving robot at a current position, and performing image segmentation on the current image to obtain a current image region related to the target object in the environment; obtaining a region difference between the expected image region and the current image region; obtaining an enlarged image of the target object based on the region difference and controlling the range imaging module to obtain depth data related to the target object in the environment; obtaining a 3D coordinate set of the target object relative to the autonomous ground-moving robot at the current position based on the depth data and the enlarged image; and updating the semantic 3D map based on the 3D coordinate set of the target object.

According to yet another aspect of the disclosure, the autonomous ground-moving robot includes an actuating module configured to move the autonomous ground-moving robot, a camera module configured to capture an image of an environment of the autonomous ground-moving robot, a range imaging module configured to obtain depth data of the environment, and a processing unit communicatively connected to the actuating module, the camera module and the range imaging module. The processing unit is configured to perform the method mentioned above for adjusting orientation of an autonomous ground-moving robot.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an autonomous ground-moving robot according to an embodiment of the present disclosure.

FIG. 2 is a flow chart illustrating a method for localizing a target for an autonomous ground-moving robot according to an embodiment of the present disclosure.

FIG. 3 is a flow chart illustrating a target-object identification procedure of the method for localizing a target according to an embodiment of the present disclosure.

FIG. 4 is a flow chart illustrating an actuating procedure of the method for localizing a target according to an embodiment of the present disclosure.

FIG. 5 is a flow chart illustrating a method for adjusting orientation of an autonomous ground-moving robot according to an embodiment of the present disclosure.

FIG. 6 is a flow chart illustrating a movement procedure of the method for adjusting orientation of an autonomous ground-moving robot according to an embodiment of the present disclosure.

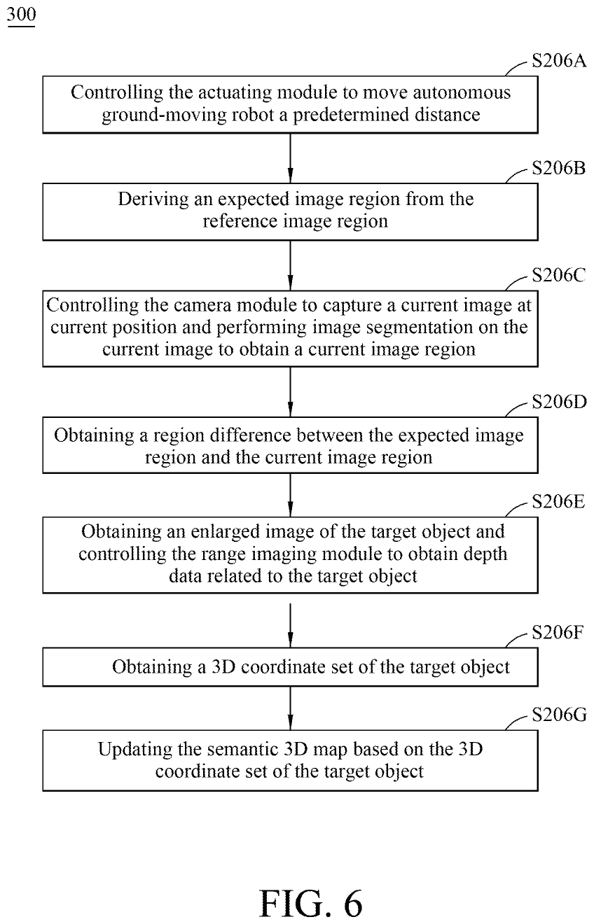

FIG. 7 is a schematic view illustrating a multi-lens camera of the autonomous ground-moving robot according to an embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

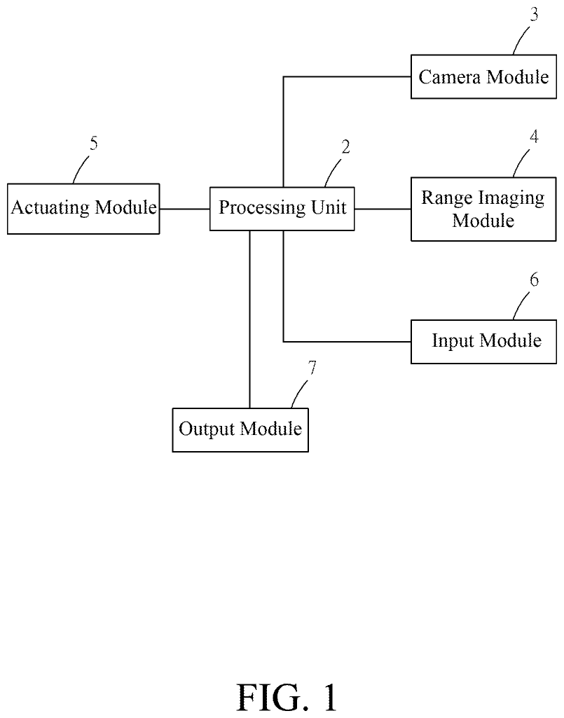

Referring to FIG. 1, an autonomous ground-moving robot according to an embodiment of the present disclosure includes a processing unit 2, and a camera module 3, a range imaging module 4 and an actuating module 5 that are communicatively connected to the processing unit 2. In this embodiment, the autonomous ground-moving robot may be exemplified as one of a humanoid robot, a wheeled robot, a tracked robot, a multi-legged robot or a hybrid robot that moves on a ground or surface environment.

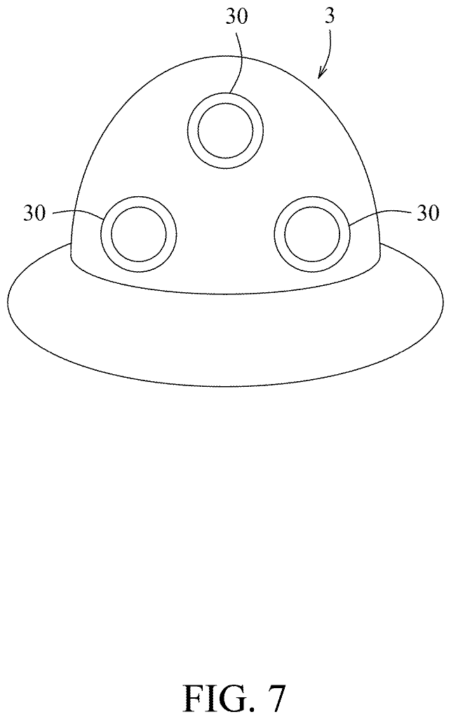

The camera module 3 is configured to capture an image of an environment of the autonomous ground-moving robot. In this embodiment, the camera module 3 is exemplified by a pan-tilt-zoom (PTZ) camera that is configured to adjust a pan angle, a tilt angle and a focal length, but the camera module 3 is not limited to such. In some embodiments, the camera module 3 may include a pan-tilt structure (not shown) having a 360 degrees panning angle and a 90 degrees tilting angle, and a camera (not shown) having 10× to 30× optical zoom and auto-focus capabilities. In an embodiment shown in FIG. 7, the camera module 3 is a multi-lens camera that includes multiple lenses 30 respectively having different focal lengths (e.g., an ultra-wide-angle lens, a wide-angle lens, a telephoto lens, etc.). The camera module 3 is disposed on the autonomous ground-moving robot (e.g., on a top part of the autonomous ground-moving robot or at other parts of the autonomous ground-moving robot that have multiple degrees of freedom as long as a field of view of the camera module 3 is not obstructed by the autonomous ground-moving robot). For example, the camera module 3 may be disposed on a head of a humanoid robot. In such an example, a pointing direction of the camera module 3 may be adjusted by the humanoid robot turning its head in a left-right direction, tilting its head in an up-down direction, or the humanoid robot moving its whole body. In some other embodiments, the camera module 3 may include a camera platform (not shown) that has at least one degree of freedom (e.g., pan, tilt, or vertical movement), and a camera unit (not shown) that includes a combination of cameras with different focal lengths (e.g., a panoramic camera and a telephoto camera; a wide-angle camera and a telephoto camera with a steerable mirror mechanism; or a wide-angle camera and a telephoto camera).

The range imaging module 4 is configured to obtain depth data of the environment. In this embodiment, the range imaging module 4 is exemplified as a light detection and ranging (LiDAR) sensor. In other embodiments, the range imaging module 4 may be exemplified by a red-green-blue-depth (RGB-D) sensor or a time of flight (ToF) sensor, and is not limited to such.

The actuating module 5 is configured to move the autonomous ground-moving robot. Specifically, the actuating module 5 includes a plurality of actuators (not shown) that may be embodied using brushless direct current (BLDC) motors, which are powered by a stable voltage (e.g., 12 V, 24 V, or 5 V). In a case where the autonomous ground-moving robot is a humanoid robot, the actuating module 5 may further include a pair of robotic legs of a humanoid robot; in a case where the autonomous ground-moving robot is a wheeled robot, the actuating module 5 may further include a differential-drive wheel chassis provided with two separately driven wheels placed respectively on two sides thereof, but is not limited to thereto. In some embodiments, the actuating module 5 may further include a robotic arm configured to perform a predetermined task, such as grabbing an object or pushing a button.

The processing unit 2 is communicatively connected to the camera module 3, the range imaging module 4 and the actuating module 5. In one embodiment, the processing unit 2 may include, but is not limited to, at least one of, a multi-core processor, a dual-core mobile phone processor, a microprocessor, a digital signal processor (DSP), a field programmable gate array (FPGA), an application-specific integrated circuit (ASIC) and a radio frequency integrated circuit. For example, the processing unit 2 may be exemplified as a central processing unit (CPU), a micro-processing unit (MPU), a microcontroller unit (MCU), a graphics processing unit (GPU), a tensor processing unit (TPU), or a combination thereof, but the processor is not limited to thereto.

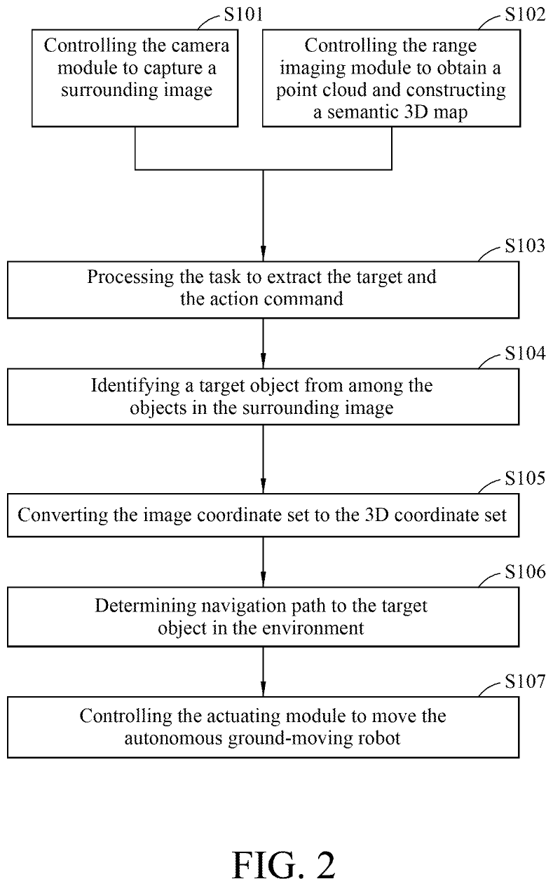

Referring to FIG. 2, a method for localizing a target for an autonomous ground-moving robot is presented, and includes steps of S101 to S107. For example, the method of FIG. 2 is for localizing a target for the autonomous ground-moving robot shown in FIG. 1, and is implemented by the processing unit 2.

In step S101, the processing unit 2 controls the camera module 3 to capture a surrounding image of the environment of the autonomous ground-moving robot. The surrounding image shows multiple objects in the environment. Specifically, the camera module 3 captures the surrounding image of the environment with a set of intrinsic parameters (e.g., focal length, principal point, distortion coefficients, etc.). In some embodiments, the camera module 3 may capture a wide-angle of the environment (e.g., a panorama). In other embodiments, the camera module 3 may capture multiple images respectively of different portions of the environment with a relatively small field of view, and combine those image into a single image as the surrounding image.

In S102, the processing unit 2 controls the range imaging module 4 to obtain a point cloud related to the environment, and constructs a semantic three-dimensional (3D) map of the environment based on the point cloud. In one embodiment, the point cloud may include a plurality of depth points each having 3D coordinate data. The processing unit 2 may construct the semantic 3D map by identifying the objects (e.g., in bounding boxes) represented by the point cloud, obtain semantic information corresponding to the objects thus identified using a trained classification model to the point cloud, and associate the semantic information with the objects thus identified, such that the semantic 3D map may represent both the geometric structure and the semantic meaning of the environment. It should be noted that steps S101 and S102 are executed independently, and they may be executed simultaneously or in an arbitrary order.

In step S103, the processing unit 2, upon receiving a task that contains a target and an action command related to the target, processes the task to extract the target and the action command therefrom. For example, the task is input by a user in a form of a user input and is a natural language command composed of natural language. In other embodiments, the task may be obtained automatically by the autonomous ground-moving robot without input by a user, and may be assigned by a scheduling module (not shown), retrieved from a work order database (not shown), received via a backend application programming interface (API), selected from a predetermined task list stored in a memory (not shown), or generated by a local artificial intelligence (AI) module (not shown).

In this embodiment, the processing unit 2 is configured to implement one or more AI models to process the user input. In some embodiments, the AI models include a language model (e.g., a large language model (LLM)). The processing unit 2 is configured to process the user input to interpret a user intent associated with the natural language command, and to determine the target and the action command based on the user intent. Since ways of interpreting the user intent using the language model to obtain information such as the target and the action command is well known in the art and is not the focus of the present disclosure, further descriptions thereof will be omitted for the sake of brevity.

In some embodiments, the autonomous ground-moving robot further includes an input module 6 that is configured to allow the user to input the natural language command as the user input. The input module 6 may be exemplified by a microphone for receiving a voice input spoken by the user as the user input, a keyboard, or a touchscreen for receiving a text input typed by the user as the user input, but is not limited to thereto. In some other embodiments, the autonomous ground-moving robot may further include an output module 7 configured to prompt the user to provide more details about the target or the action command through voice audio in a case where the processing unit 2 fails to obtain the target or the action command from the user input, and to output sound to notify or alert the user.

In step S104, the processing unit 2 identifies a target object as the target from among the objects in the surrounding image. In this embodiment, the processing unit 2 performs a target-object identification procedure 100 to identify the target object. The target-object identification procedure 100 includes sub-steps of S104A to S104D.

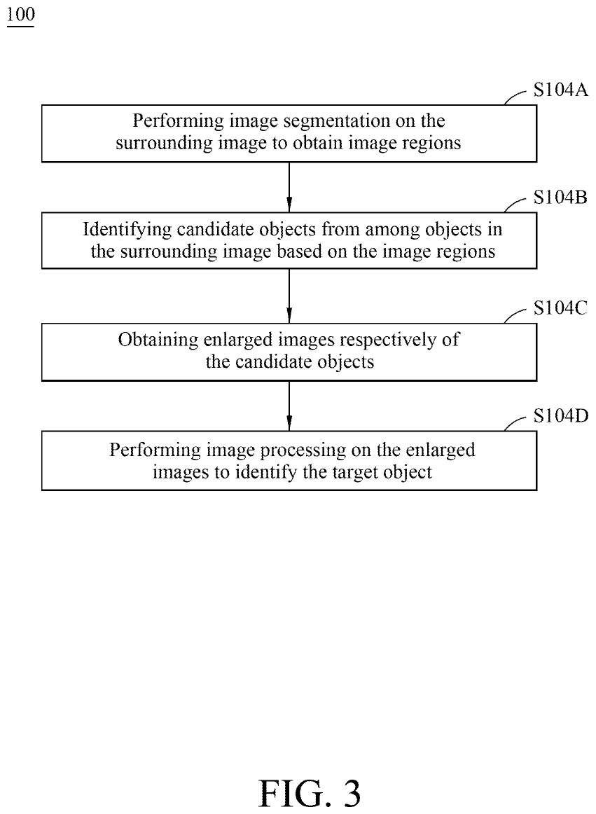

Referring to FIG. 3, in sub-step S104A, the processing unit 2 performs image segmentation on the surrounding image to obtain multiple image regions related respectively to the objects in the surrounding image. For example, the processing unit 2 may utilize an AI-based image recognition algorithm, such as the You Only Look Once (YOLO) series, to classify each of the multiple image regions in the surrounding image into one of a plurality of classes that can be identified by the processing unit 2. That is, the AI-based image recognition algorithm is trained to identify the plurality of classes.

In sub-step S104B, the processing unit 2 identifies multiple candidate objects from among the objects in the surrounding image based on the image regions. Continuing from the example above, for each of the objects in the surrounding image, the processing unit 2 first determines whether the object is classified into one of the classes that corresponds to a target class which the target belongs to, and then selects the object as the candidate object if the determination is affirmative.

In sub-step S104C, for each of the candidate objects, the processing unit 2 obtains an enlarged image of the candidate object by controlling the camera module 3 to adjust the focal length, and at least one of the pan angle and the tilt angle of the camera module 3, and then to capture the enlarged image of the candidate object. In a case that the camera module 3 is the multi-lens camera, the processing unit 2 obtains the enlarged image of the candidate object by cropping the surrounding image to obtain a cropped image corresponding to the image region of the candidate object, and resizing and rotating the cropped image to obtain the enlarged image (i.e., the cropped image thus resized and rotated) using digital interpolation. It should be noted that the enlarged image have a pixel resolution same as that of the surrounding image.

In sub-step S104D, the processing unit 2 performs image processing on the enlarged images respectively of the candidate objects to identify the target object from among the candidate objects. For example, the processing unit 2 may utilize optical character recognition (OCR) technology, quick response (QR) code recognition technology or facial recognition technology to identify which one of the candidate objects corresponds to the target. Specifically, the processing unit 2 may utilize the OCR to read a label on each of the candidate objects that distinguishes the candidate object (e.g., meters respectively labelled as “Meter 1”, “Meter 2”, “Meter 3”, etc.); the processing unit 2 may utilize the QR code recognition technology to read information about each of the candidate objects that has a QR code labeling; and the processing unit 2 may utilize the facial recognition technology to identify an individual should the target be a person in the environment.

The processing unit 2 then obtains an image coordinate set (e.g., an (x, y) coordinate set) of a position of the target object in the surrounding image. In this embodiment, the image coordinate set is defined by an image coordinate system related to the camera module 3.

In step S105, the processing unit 2 converts the image coordinate set to a 3D coordinate set defined by a sensor coordinate system fixed to the range imaging module 4. In this embodiment, the processing unit 2 converts the image coordinate set to the 3D coordinate set defined by the sensor coordinate system fixed to the range imaging module 4 based on the intrinsic parameters of the camera module 3 and a transformation matrix, where the transformation matrix is a combination of rotation and translation matrices.

The processing unit 2 is further configured to perform a calibration procedure to obtain the transformation matrix in advance. In the calibration procedure, the processing unit 2 controls the camera module 3 to capture a reference image that has a plurality of reference objects. For each of the reference objects, the processing unit 2 obtains a reference image coordinate set in the image coordinate system based on the reference image. The processing unit 2 also controls the range imaging module 4 to obtain a point cloud related to the plurality of reference objects. For each of the reference objects, the processing unit 2 obtains a reference 3D coordinate set in the sensor coordinate system based on the point cloud thus obtained. Finally, the processing unit 2 obtains the transformation matrix based on the reference image coordinate sets respectively of the reference objects and the reference 3D coordinate sets respectively of the reference objects.

In step S106, the processing unit 2 determines a navigation path the target object in the environment based on the semantic 3D map and the 3D coordinate set.

In some embodiments, prior to determining the navigation path, the processing unit 2 estimates a pose of the autonomous ground-moving robot in the environment based on the surrounding image obtained by the camera module 3 and the point cloud obtained by the range imaging module 4, and updates the semantic 3D map based on the pose of the autonomous ground-moving robot.

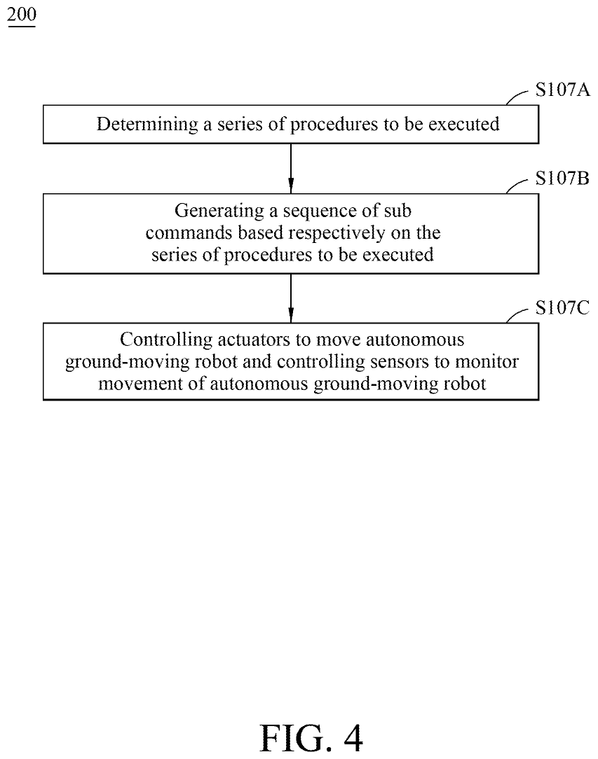

In step S107, the processing unit 2 controls the actuating module 5 to move the autonomous ground-moving robot based on the action command. In this embodiment, the actuating module 5 further includes a plurality of sensors such as an infrared sensor, a temperature sensor and an inertial sensor, and the processing unit 2 controls the actuating module 5 to move the autonomous ground-moving robot by performing an actuating procedure 200 that includes sub-steps of S107A to S107C (see FIG. 4). In some embodiments, the sensors of the actuating module 5 include the camera module 3 and the range imaging module 4.

In sub-step S107A, the processing unit 2 determines a series of procedures to be executed based on the target and the action command, where each procedure in the series of procedures is to be executed by one of the actuators and the sensors of the actuating module 5. For example, in the series of procedures, one procedure may be executed by the motor to move the autonomous ground-moving robot, and another procedure may be executed by the infrared sensor to measure a distance from the infrared sensor to the target object. In some embodiments, the processing unit 2 determines the series of procedures using the LLM. In other embodiments, the processing unit 2 may determine the series of procedures using a behavior tree, but is not limited to such.

In sub-step S107B, the processing unit 2 then generates a sequence of sub commands in a machine-readable format based respectively on the series of procedures to be executed.

In sub-step S107C, the processing unit 2 controls the actuators to move the autonomous ground-moving robot, and controls the sensors to monitor movement of the autonomous ground-moving robot based on the sequence of sub commands.

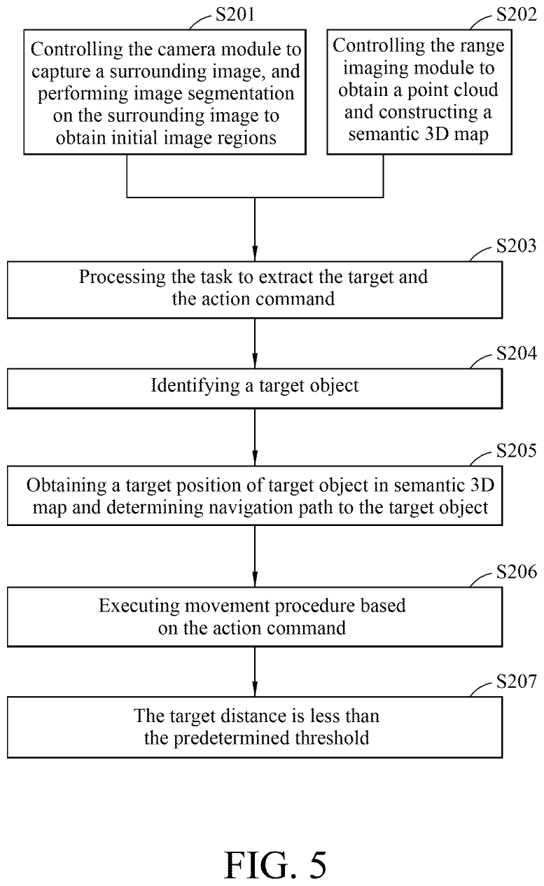

Referring to FIG. 5, a method for adjusting orientation of an autonomous ground-moving robot according to an embodiment of the present disclosure is provided. For example, the method of FIG. 5 is for adjusting orientation of the autonomous ground-moving robot shown in FIG. 1 and includes steps S201 to S207.

In step S201, the processing unit 2 controls the camera module to capture a surrounding image of the environment of the autonomous ground-moving robot, where the surrounding image has multiple objects in the environment. Then, the processing unit 2 performs image segmentation (e.g., using the YOLO series) on the surrounding image to obtain multiple initial image regions related respectively to the objects in the environment.

In step S202, the processing unit 2 controls the range imaging module 4 to obtain a point cloud related to the environment, and constructs a semantic 3D map of the environment based on the point cloud. It should be noted that steps S201 and S202 are executed independently, and they may be executed simultaneously or in an arbitrary order.

In step S203, upon receiving a task that contains a target and an action command related to the target, the processing unit 2 processes the task to extract the target and the action command in the task. It should be noted that steps S202 and S203 of the method of FIG. 5 is similar respectively to steps S102 and S103 of the method of FIG. 2, and details thereof are omitted herein for the sake of brevity.

In step S204, the processing unit 2 identifies a target object as the target from among the objects in the surrounding image.

In one embodiment, the processing unit 2 further performs feature extraction on the surrounding image to obtain multiple attributes of the target object, and assigns a semantic label indicating the attributes of the target object in the semantic 3D map. The attributes of the target object may include, for example, a color or a class of the target object.

In step S205, the processing unit 2 obtains a target position of the target object in the semantic 3D map, and determines a navigation path to the target object based on the semantic 3D map and the target position.

In step S206, the processing unit 2 executes a movement procedure 300 based on the action command. The movement procedure 300 includes sub-steps S206A to S206G.

In sub-step S206A, the processing unit 2 controls the actuating module 5 to move the autonomous ground-moving robot by a predetermined distance along the navigation path. It should be noted that, when the autonomous ground-moving robot has accurately moved the predetermined distance along the navigation path, the autonomous ground-moving robot is expected to be located at an expected position.

In sub-step S206B, the processing unit 2 derives an expected image region from a reference image region that is one of the initial image regions related to the target object based on the predetermined distance, the semantic 3D map and the navigation path.

In sub-step S206C, after the processing unit 2 controls the actuating module 5 to move the autonomous ground-moving robot in sub-step S206A, the processing unit 2 controls the camera module 3 to capture a current image of the environment of the autonomous ground-moving robot that is currently located at a current position, and performs image segmentation on the current image to obtain a current image region related to the target object in the environment. It should be noted that the current position refers to a real position where the autonomous ground-moving robot is exactly located after sub-step S206A, and may deviate from the expected position due to gait instability, terrain irregularities, or sensor drift.

In sub-step S206D, the processing unit 2 obtains a region difference between the expected image region and the current image region. In one embodiment, the processing unit 2 obtains a shape difference between the expected image region and the current image region, and implement the shape difference as the region difference. Specifically, to obtain the shape difference, the processing unit 2 obtains an expected shape of the expected image region, obtains a current shape of the current image region, and obtains a difference between the expected shape and the current shape as the shape difference. In another embodiment, the processing unit 2 obtains a position difference between the expected image region and the current image region, and implement the position difference as the region difference. Specifically, to obtain the position difference, the processing unit 2 derives an expected-image position of the expected image region in the image captured by the camera module 3 at the expected position, obtains a current-image position of the current image region in the current image, and obtains a difference between the expected-image position and the current-image position as the position difference. In another embodiment, the region difference includes both the shape difference and the positon difference.

In sub-step S206E, the processing unit 2 obtains an enlarged image of the target object based on the region difference and controls the range imaging module 4 to obtain depth data related to the target object in the environment.

Specifically, in sub-step S206E, the processing unit 2 adjusts orientation of the camera module 3 based on the region difference to center the target object within the field of view of the camera module 3. Then, the processing unit 2 adjusts the focal length of the camera module 3 to narrow the field of view. After adjusting the focal length of the camera module 3, the processing unit 2 controls the camera module 3 to capture an enlarged image of the target object and controls the range imaging module 4 to obtain depth data related to the target object in the environment.

In a case that the camera module 3 is the multi-lens camera, the processing unit 2 obtains the enlarged image of the target object, in sub-step 206E, by cropping the surrounding image to obtain a cropped image corresponding to the current image region of the target object, and resizing and rotating the cropped image to obtain the enlarged image (i.e., the cropped image thus resized and rotated) based on the region difference using digital interpolation. It should be noted that the enlarged image have a pixel resolution same as that of the surrounding image.

In sub-step S206F, the processing unit 2 obtains a 3D coordinate set of the target object relative to the autonomous ground-moving robot at the current position based on the depth data and the enlarged image. Specifically, the 3D coordinate set of the target object includes a target distance from the range imaging module 4 to the target object.

In sub-step S206G, the processing unit 2 updates the semantic 3D map based on the 3D coordinate set of the target object. In one embodiment, before updating the semantic 3D map, the processing unit 2 estimates a pose of the autonomous ground-moving robot in the environment based on the current image and the point cloud obtained by the range imaging module 4, and transforms the 3D coordinate set of the target object into a coordinate frame of the semantic 3D map based on the pose of the autonomous ground-moving robot.

In some embodiments, the method for adjusting orientation of an autonomous ground-moving robot further includes a step S207 after step S206; in step S207, the processing unit 2 determines whether the target distance is less than a predetermined threshold. When the processing unit 2 determines that the target distance is not less than the predetermined threshold, the flow goes back to step S206 for the processing unit 2 to repeat the movement procedure 300 with the target image region obtained in the last execution of the movement procedure 300 serving as the reference image region for deriving the expected image region in the current execution of the movement procedure 300. When the processing unit 2 determines that the target distance is less than the predetermined threshold, the processing unit 2 may control the actuating module 5 to perform further actions according to the action command, such as performing OCR, QR code recognition or object manipulation on the target object.

In summary, by the autonomous ground-moving robot performing the method for localizing a target for an autonomous ground-moving robot according to embodiments of this disclosure, the autonomous ground-moving robot is able to receive a natural language command composed of natural language as the user input from the user, and autonomously obtain the 3D coordinate set of the target object in the sensor coordinate system based on the image coordinate set of a position of the target object in the surrounding image in the image coordinate system. By virtue of the aforementioned arrangements, the autonomous ground-moving robot of this disclosure is able to autonomously perform wide-area searching, zoomed inspection, 3D target localization, and integration of target localization information into a mapping framework for subsequent autonomous tasks.

In addition, by the autonomous ground-moving robot performing the method for adjusting orientation of an autonomous ground-moving robot according to embodiments of this disclosure, while the autonomous robot is moving along the navigation path to the target object, the autonomous ground-moving robot autonomously adjusts orientation of the camera module 3 based on the region difference to center the target object within the field of view of the camera module 3. By virtue of the aforementioned arrangements, the autonomous ground-moving robot of this disclosure may overcome pose estimation errors that may be caused by gait instability, terrain irregularities, or sensor drift when the autonomous ground-moving robot is moving to the target object, thereby enabling the autonomous ground-moving robot to accurately reach the target object, and allowing the autonomous ground-moving robot to carry out the action command on the target successfully.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for localizing a target for an autonomous ground-moving robot, the autonomous ground-moving robot including a camera module for capturing an image of an environment of the autonomous ground-moving robot, a range imaging module for obtaining depth data of the environment, an actuating module for moving the autonomous ground-moving robot, and a processing unit, the method being implemented by the processing unit and comprising steps of:
controlling the camera module to capture a surrounding image of the environment of the autonomous ground-moving robot, the surrounding image having multiple objects in the environment;
controlling the range imaging module to obtain a point cloud related to the environment, and constructing a semantic three-dimensional (3D) map of the environment based on the point cloud;
upon receiving a task that contains a target and an action command related to the target, processing the task to extract the target and the action command in the task;
identifying a target object as the target from among the objects in the surrounding image, and obtaining an image coordinate set of a position of the target object in the surrounding image, the image coordinate set being defined by an image coordinate system related to the camera module;
converting the image coordinate set to a 3D coordinate set defined by a sensor coordinate system fixed to the range imaging module;
determining a navigation path to the target object in the environment based on the semantic 3D map and the 3D coordinate set; and
controlling the actuating module to move the autonomous ground-moving robot based on the action command.

2. The method as claimed in claim 1, wherein:
in the step of controlling the camera module to capture the surrounding image, the camera module captures the surrounding image with a set of intrinsic parameters; and
the step of converting the image coordinate set to the 3D coordinate set is to convert the image coordinate set to the 3D coordinate set based on the set of intrinsic parameters and a transformation matrix.

3. The method as claimed in claim 2, further comprising steps of:
controlling the camera module to capture a reference image having a plurality of reference objects, and, for each of the plurality of reference objects, obtaining a reference image coordinate set in the image coordinate system based on the reference image;
controlling the range imaging module to obtain a point cloud related to the plurality of reference objects, and, for each of the plurality of reference objects, obtaining a reference 3D coordinate set in the sensor coordinate system based on the point cloud thus obtained; and
obtaining the transformation matrix based on the reference image coordinate sets respectively of the plurality of reference objects and the reference 3D coordinate sets respectively of the plurality of reference objects.

4. The method as claimed in claim 1, the camera module being a pan-tilt-zoom (PTZ) camera configured to adjust a pan angle, a tilt angle and a focal length, the range imaging module including one of a light detection and ranging (LiDAR) sensor, a red-green-blue-depth (RGB-D) sensor and a time of flight (ToF) sensor,
wherein the step of identifying the target object as the target from among the objects includes sub-steps of:
performing image segmentation on the surrounding image to obtain multiple image regions related respectively to the objects in the surrounding image;
identifying multiple candidate objects from among the objects in the surrounding image based on the image regions;
for each of the candidate objects, controlling the camera module to adjust the focal length, and at least one of the pan angle and the tilt angle of the camera module, and then capture an enlarged image of the candidate object; and
performing image processing on the enlarged images respectively of the candidate objects to identify the target object from among the candidate objects.

5. The method as claimed in claim 1, the camera module being a multi-lens camera that includes multiple lenses respectively having different focal lengths, the range imaging module including one of a light detection and ranging (LiDAR) sensor, a red-green-blue-depth (RGB-D) sensor and a time of flight (ToF) sensor,
wherein the step of identifying the target object as the target from among the objects includes sub-steps of:
performing image segmentation on the surrounding image to obtain multiple image regions related respectively to the objects in the surrounding image;
identifying multiple candidate objects from among the objects in the surrounding image based on the image regions;
for each of the candidate objects, obtaining an enlarged image of the candidate object by cropping the surrounding image to obtain a cropped image corresponding to the image region of the candidate object, and resizing and rotating the cropped image to obtain the enlarged image using digital interpolation;
performing image processing on the enlarged images respectively of the candidate objects to identify the target object from among the candidate objects.

6. The method as claimed in claim 1, the autonomous ground-moving robot further including an input module configured to receive the task in a form of a user input that is a natural language command from a user,
wherein the step of processing the task to extract the target and the action command includes sub-steps of processing the natural language command using a large language model (LLM) to interpret a user intent of the natural language command, and determining the target and the action command from the user intent.

7. The method as claimed in claim 6, the actuating module including multiple actuators and multiple sensors, wherein the step of controlling the actuating module to move the autonomous ground-moving robot based on the action command includes sub-steps of:
determining a series of procedures to be executed based on the target and the action command, each procedure in the series of procedures to be executed by one of the actuators and the sensors;
generating a sequence of sub commands in a machine-readable format based respectively on the series of procedures to be executed; and
based on the sequence of sub commands, controlling the actuators to move the autonomous ground-moving robot and controlling the sensors to monitor movement of the autonomous ground-moving robot.

8. The method as claimed in claim 1, further comprising steps of:
estimating a pose of the autonomous ground-moving robot in the environment based on the surrounding image obtained by the camera module and the point cloud obtained by the range imaging module; and
updating the semantic 3D map based on the pose of the autonomous ground-moving robot.

9. An autonomous ground-moving robot, comprising:
an actuating module configured to move the autonomous ground-moving robot;
a camera module configured to capture an image of an environment of the autonomous ground-moving robot;
a range imaging module configured to obtain depth data of the environment; and
a processing unit communicatively connected to said actuating module, said camera module and said range imaging module, and configured to perform a method as claimed in claim 1.

10. The autonomous ground-moving robot as claimed in claim 9, wherein said camera module is configured to capture the surrounding image with a set of intrinsic parameters, and said processing unit is configured to convert the image coordinate set to the 3D coordinate set based on the set of intrinsic parameters and a transformation matrix.

11. The autonomous ground-moving robot as claimed in claim 10, wherein said processing unit is further configured to
control said camera module to capture a reference image having a plurality of reference objects, and, for each of the plurality of reference objects, obtain a reference image coordinate set in the image coordinate system based on the reference image,
control said range imaging module to obtain a point cloud related to the plurality of reference objects, and, for each of the plurality of reference objects, obtain a reference 3D coordinate set in the sensor coordinate system based on the point cloud thus obtained, and
obtain the transformation matrix based on the reference image coordinate sets respectively of the plurality of reference objects and the reference 3D coordinate sets respectively of the plurality of reference objects.

12. The autonomous ground-moving robot as claimed in claim 9, wherein said camera module is a pan-tilt-zoom (PTZ) camera configured to adjust a pan angle, a tilt angle and a focal length, and said range imaging module includes one of a light detection and ranging (LiDAR) sensor, a red-green-blue-depth (RGB-D) sensor and a time of flight (ToF) sensor; and
wherein said processing unit is configured to
perform image segmentation on the surrounding image to obtain multiple image regions related respectively to the objects in the surrounding image,
identify multiple candidate objects from among the objects in the surrounding image based on the image regions,
for each of the candidate objects, control said camera module to adjust the focal length, and at least one of the pan angle and the tilt angle of said camera module, and then capture an enlarged image of the candidate object, and
perform image processing on the enlarged images respectively of the candidate objects to identify the target object from among the candidate objects.

13. The autonomous ground-moving robot as claimed in claim 9, wherein said camera module is a multi-lens camera that includes multiple lenses respectively having different focal lengths, and said range imaging module includes one of a light detection and ranging (LiDAR) sensor, a red-green-blue-depth (RGB-D) sensor and a time of flight (ToF) sensor; and
wherein said processing unit is configured to
perform image segmentation on the surrounding image to obtain multiple image regions related respectively to the objects in the surrounding image,
identify multiple candidate objects from among the objects in the surrounding image based on the image regions,
for each of the candidate objects, obtain an enlarged image of the candidate object by cropping the surrounding image to obtain a cropped image corresponding to the image region of the candidate object, and resizing and rotating the cropped image to obtain the enlarged image based on the region difference using digital interpolation, and
perform image processing on the enlarged images respectively of the candidate objects to identify the target object from among the candidate objects.

14. The autonomous ground-moving robot as claimed in claim 9, further comprising an input module configured to receive the task in a form of a user input that is a natural language command from a user, wherein said processing unit is configured to process the natural language command using a large language model (LLM) to interpret a user intent of the natural language command, and determine the target and the action command from the user intent.

15. The autonomous ground-moving robot as claimed in claim 14, wherein said actuating module includes multiple actuators and multiple sensors; and
wherein said processing unit is configured to
determine a series of procedures to be executed based on the target and the action command, each procedure in the series of procedures to be executed by one of said actuators and said sensors,
generate a sequence of sub commands in a machine-readable format based respectively on the series of procedures to be executed, and
based on the sequence of sub commands, control said actuators to move the autonomous ground-moving robot and control said sensors to monitor movement of the autonomous ground-moving robot.

16. The autonomous ground-moving robot as claimed in claim 9, wherein said processing unit is further configured to estimate a pose of the autonomous ground-moving robot in the environment based on the surrounding image obtained by said camera module and point cloud obtained by said range imaging module, and update the semantic 3D map based on the pose of the autonomous ground-moving robot.

17. A method for adjusting orientation of an autonomous ground-moving robot, the autonomous ground-moving robot including a camera module for capturing an image of an environment of the autonomous ground-moving robot, a range imaging module for obtaining depth data of the environment, an actuating module for moving the autonomous ground-moving robot, and a processing unit, the method to be implemented by the processing unit and comprising steps of:
controlling the camera module to capture a surrounding image of the environment of the autonomous ground-moving robot, the surrounding image having multiple objects in the environment;
performing image segmentation on the surrounding image to obtain multiple initial image regions related respectively to the objects in the environment;
controlling the range imaging module to obtain a point cloud related to the environment, and constructing a semantic 3D map of the environment based on the point cloud;
upon receiving a task that contains a target and an action command related to the target, processing the task to extract the target and the action command in the task;
identifying a target object as the target from among the objects in the surrounding image;
obtaining a target position of the target object in the semantic 3D map, and determining a navigation path to the target object based on the semantic 3D map and the target position; and
executing a movement procedure based on the action command, the movement procedure including
controlling the actuating module to move the autonomous ground-moving robot by a predetermined distance along the navigation path, the autonomous ground-moving robot being expected to be located at an expected position after accurately moving the predetermined distance along the navigation path,
based on the predetermined distance, the semantic 3D map and the navigation path, deriving an expected image region from a reference image region that is one of the initial image regions related to the target object, the expected image region being an image region of an image captured by the camera module at the expected position,
after controlling the actuating module to move the autonomous ground-moving robot, controlling the camera module to capture a current image of the environment of the autonomous ground-moving robot at a current position, and performing image segmentation on the current image to obtain a current image region related to the target object in the environment,
obtaining a region difference between the expected image region and the current image region,
obtaining an enlarged image of the target object based on the region difference and controlling the range imaging module to obtain depth data related to the target object in the environment,
obtaining a 3D coordinate set of the target object relative to the autonomous ground-moving robot at the current position based on the depth data and the enlarged image, and
updating the semantic 3D map based on the 3D coordinate set of the target object.

18. The method as claimed in claim 17, the camera module being a pan-tilt-zoom (PTZ) camera configured to adjust a pan angle, a tilt angle and a focal length, wherein obtaining the enlarged image of the target object based on the region difference and controlling the range imaging module to obtain the depth data related to the target object includes:
adjusting orientation of the camera module based on the region difference to center the target object within a field of view of the camera module, and then adjusting a focal length of the camera module to narrow the field of view; and
after adjusting the focal length of the camera module, controlling the camera module to capture the enlarged image of the target object and controlling the range imaging module to obtain depth data related to the target object in the environment.

19. The method as claimed in claim 17, the camera module being a multi-lens camera that includes multiple lenses respectively having different focal lengths, wherein obtaining the enlarged image of the target object based on the region difference includes:
cropping the surrounding image to obtain a cropped image corresponding to the current image region of the target object; and
resizing and rotating the cropped image to obtain the enlarged image based on the region difference using digital interpolation.

20. The method as claimed in claim 17, wherein obtaining the 3D coordinate set of the target object includes obtaining a target distance from the range imaging module to the target object.

21. The method as claimed in claim 20, further comprising:
determining whether the target distance is less than a predetermined threshold;
in response to determining that the target distance is not less than the predetermined threshold, repeating the movement procedure with the target image region obtained in a last execution of the movement procedure serving as the reference image region for deriving the expected image region in current execution of the movement procedure.

22. The method as claimed in claim 17, wherein obtaining the region difference between the expected image region and the current image region includes obtaining one of a shape difference and a position difference, and implementing said one of the shape difference and the position difference as the region difference,
wherein obtaining the shape difference includes obtaining an expected shape of the expected image region, obtaining a current shape of the current image region, and obtaining a difference between the expected shape and the current shape as the shape difference,
wherein obtaining the position difference includes deriving an expected-image position of the expected image region in the image captured by the camera module at the expected position, obtaining a current-image position of the current image region in the current image, and obtaining a difference between the expected-image position and the current-image position as the position difference.

23. The method as claimed in claim 17, further comprising steps of:
performing feature extraction on the surrounding image to obtain multiple attributes of the target object; and
assigning a semantic label indicating the attributes of the target object in the semantic 3D map.

24. The method as claimed in claim 17, further comprising steps of, before updating the semantic 3D map based on the 3D coordinate set of the target object:
estimating a pose of the autonomous ground-moving robot in the environment based on the current image and the point cloud obtained by the range imaging module; and
transforming the 3D coordinate set of the target object into a coordinate frame of the semantic 3D map based on the pose of the autonomous ground-moving robot.

25. An autonomous ground-moving robot, comprising:
an actuating module configured to move the autonomous ground-moving robot;
a camera module configured to capture an image of an environment of the autonomous ground-moving robot;
a range imaging module configured to obtain depth data of the environment; and
a processing unit communicatively connected to said actuating module, said camera module, and said range imaging module, and configured to perform a method as claimed in claim 17.

26. The autonomous ground-moving robot as claimed in claim 25, wherein said processing unit is configured to obtain a target distance from the range imaging module to the target object to obtain the 3D coordinate set of the target object.

27. The autonomous ground-moving robot as claimed in claim 26, wherein said processing unit is further configured to determine whether the target distance is less than a predetermined threshold, and, in response to determining that the target distance is not less than the predetermined threshold, repeat the movement procedure with the target image region obtained in a last execution of the movement procedure serving as the reference image region for deriving the expected image region in current execution of the movement procedure.

28. The autonomous ground-moving robot as claimed in claim 25, wherein said processing unit is configured to obtain one of a shape difference and a position difference, and implement said one of the shape difference and the position difference as the region difference;
wherein said processing unit is configured to obtain an expected shape of the expected image region, obtain a current shape of the current image region, and obtain a difference between the expected shape and the current shape as the shape difference; and
wherein said processing unit is configured to derive an expected-image position of the expected image region in the image captured by said camera module at the expected position, obtain a current-image position of the current image region in the current image, and obtain a difference between the expected-image position and the current-image position as the position difference.

29. The autonomous ground-moving robot as claimed in claim 25, wherein said processing unit is further configured to perform feature extraction on the surrounding image to obtain multiple attributes of the target object, and assign a semantic label indicating the attributes of the target object in the semantic 3D map.
